(19) United States
(12) Patent Application Publication
(10) Pub. No.: US 2020/0182753 A1
(43) Pub. Date: Jun. 11, 2020

(54) METHOD FOR IDENTIFYING EMBEDDED SAMPLES FOR MICROSCOPY

(71) Applicant: Gourgen AMBARTSOUMIAN, Laval (CA)

(72) Inventors: Gourgen AMBARTSOUMIAN, Laval (CA); Bronwen FORWARD, Montreal (CA)

(21) Appl. No.: 16/614,988

(22) PCT Filed: May 18, 2018
(86) PCT No.: PCT/CA2018/050588

§ 371 Date: Nov. 19, 2019

Related U.S. Application Data
(60) Provisional application No. 62/508,707, filed on May 19, 2017.

(51) Int. Cl. G01N 1/36

(52) U.S. Cl. CPC G01N 1/36; G01N 2035/00861

(57) ABSTRACT

A kit comprises one or more sample containers adapted to receive a sample and an embedding substance solidifiable to embed items in the sample container. A liquid embedding substance is adapted to be received in an inner cavity of the sample container. An identification label adapted to be received in an inner cavity of the sample container and configured to have data identifying the sample in the sample container, the label being resistant to chemicals of the embedding substance. The kit may be assembled into the sample container, solidified embedding substance in an inner cavity of the sample container, a sample embedded in the solidified embedding substance, and an identification label embedded in the solidified embedding substance, the identification label having data identifying the sample.

### CROSS-REFERENCE TO RELATED APPLICATION

The present application claims the priority of U.S. Provisional Patent Application Ser. No. 62/508,707, filed on May 19, 2017 and incorporated herein by reference.

### FIELD OF THE INVENTION

The present application relates to the identification of embedded samples prior to the embedding for subsequent identification and observation in microscopy.

### BACKGROUND OF THE ART

Prior to sample observation using light or electron microscopy, biological samples must first be preserved and embedded in a solid medium, allowing for sectioning and subsequent viewing. In electron microscopy, samples are fixed and dehydrated in ethanol, acetone, isopropanol, or some other dehydrating agent. Following dehydration, the samples are commonly infiltrated with a resin medium that polymerizes and hardens, resulting in a solid block containing the sample. The properties of these resins allow the block and sample to be easily trimmed and sectioned with a microtome before being affixed to a slide or grid support.

Resins are often provided in kits as separate components that are mixed together prior to the polymerization process. While different types of resins can vary in terms of ingredients, they typically consist of a polymerizing substance, a chemical hardener, a ‘flexibilizer’ that controls the degree of polymerization, and an accelerator that is used to reduce the cure time. The proportions of these reagents can be adjusted to achieve the desired resin properties.

Preserving the identity of samples within resin blocks is a critical task. Interpretation of minor differences between sample types relies on proper identification of each block. Furthermore, the embedded samples serve an important archival purpose. As the resulting resin blocks are completely solid and inert, the samples contained within them remain preserved indefinitely, and can be recalled at any time for future analyses. As the resin containers are disposable, and used to temporarily hold the block and sample, it is highly preferable to embed the sample ID label in the resin block with the sample. Surprisingly, methods for securing the identity of these blocks remains relatively unsophisticated, with laboratories most commonly constructing their own paper labels containing data written in pencil.

### SUMMARY

It is therefore an aim of the present disclosure to provide a method for identifying embedded samples for microscopy that addresses issues related to the prior art.

Therefore, in accordance with first embodiment of the present disclosure, there is provided a method for identifying embedded samples for microscopy, comprising: obtaining a sample container with an identification label in the sample container, associating the identification label to a specific sample, inserting the specific sample in a sample container, filling at least partially the sample container including the specific sample with an embedding substance, and placing the sample container including the liquid embedding substance submerging the specific sample and the identification label associated with the specific sample for embedding treatment.

Further in accordance with the first embodiment of the present disclosure, obtaining the sample container includes folding the identification label on itself for an adhesive or static cling to join halves of the identification label together.

Still further in accordance with the first embodiment of the present disclosure, obtaining the sample container with the identification label includes for instance obtaining the identification label with an ink identification code, an ink of the ink identification code and the label being embedding substance resistant to sample embedding chemicals.

Still further in accordance with the first embodiment of the present disclosure, obtaining the identification label with an ink identification code includes for instance obtaining the identification label with the ink identification code on both sides of the label.

Still further in accordance with the first embodiment of the present disclosure, obtaining the sample container with the identification label includes for instance inserting the identification label associated to the specific sample in the sample container such that the folded label is submerged by the embedding substance.

Still further in accordance with the first embodiment of the present disclosure, filling at least partially the sample container includes for instance filling the sample container partially with embedding substance to leave a space free of embedding substance, and filling the space free of embedding substance after insertion of the identification label in the space free of embedding substance.

Still further in accordance with the first embodiment of the present disclosure, inserting the identification label in the sample container includes for instance inserting the identification label with a curvature therein in the sample container.

Still further in accordance with the first embodiment of the present disclosure, the sample container is for instance removed to expose the sample and identification label embedded in solidified embedding substance.

Still further in accordance with the first embodiment of the present disclosure, the sample and identification label embedded in solidified embedding substance is for instance sectioned after removal of the sample container.

Still further in accordance with the first embodiment of the present disclosure, an identity of the sample is for instance determined using the identification label.

Still further in accordance with the first embodiment of the present disclosure, determining an identity of the sample using the identification code includes for instance scanning the identification label to retrieve the identity of the sample.

Still further in accordance with the first embodiment of the present disclosure, an RFID or NFC tag or wireless communication device is for instance into the identification label.

Still further in accordance with the first embodiment of the present disclosure, obtaining the RFID or NFC tag or wireless communication device into the identification label includes for instance folding the identification label on itself to embed the RFID or NFC tag or wireless communication device into the identification label.

Still further in accordance with the first embodiment of the present disclosure, an identification is for instance encoded in the RFID or NFC tag or wireless communication device.

Still further in accordance with the first embodiment of the present disclosure, the identification label is for instance obtained without any printing thereon.

Still further in accordance with the first embodiment of the present disclosure, the identification code is for instance printed on the identification label.

Still further in accordance with the first embodiment of the present disclosure, associating the identification label to a specific sample includes for instance scanning an identification code on the identification label.

In accordance with a second embodiment of the present disclosure, there is provided an assembly comprising: at least one sample container, solidified embedding substance in an inner cavity of the sample container, a sample embedded in the solidified embedding substance, and an identification label embedded in the solidified embedding substance, the identification label having data identifying the sample.

Further in accordance with the second embodiment of the present disclosure, the at least one sample container has for instance an inner diameter of less than 15mm.

Still further in accordance with the second embodiment of the present disclosure, the sample container is for instance one of an embedding capsule and gelatin capsule.

Still further in accordance with the second embodiment of the present disclosure, the sample container is for instance part of a plurality of interconnected sample containers.

Still further in accordance with the second embodiment of the present disclosure, the solidified embedding substance is for instance one of epoxy, polymer, epoxide resin, diglycidyl ether of polypropylene glycol, nonenyl succinic anhydride, and dimethylaminoethanol.

Still further in accordance with the second embodiment of the present disclosure, the identification label is for instance a label having an adhesive or static cling and folded on itself.

Still further in accordance with the second embodiment of the present disclosure, the identification label in the solidified embedding substance has for instance a length greater than an inner diameter of the sample container.

Still further in accordance with the second embodiment of the present disclosure, the identification label has for instance an ink identification code on at least one of its exposed surfaces, an ink of the ink identification code and the label being resistant to chemicals of the embedding substance.

Still further in accordance with the second embodiment of the present disclosure, the identification label has for instance the ink identification code on both of its exposed surfaces.

Still further in accordance with the second embodiment of the present disclosure, the identification label includes for instance an RFID or NFC tag or wireless communication device.

In accordance with the third embodiment of the present disclosure, there is provided a kit comprising: at least one sample container adapted to receive a sample and an embedding substance solidifiable to embed items in the at least one sample container, liquid embedding substance adapted to be received in an inner cavity of the sample container, an identification label adapted to be received in an inner cavity of the sample container and configured to have data identifying the sample in the sample container, the label being resistant to chemicals of the embedding substance.

Further in accordance with the third embodiment of the present disclosure, the at least one sample container has for instance an inner diameter of less than 15mm.

Still further in accordance with the third embodiment of the present disclosure, the sample container is for instance one of an embedding capsule and gelatin capsule.

Still further in accordance with the third embodiment of the present disclosure, the sample container is for instance part of a plurality of interconnected sample containers.

Still further in accordance with the third embodiment of the present disclosure, the liquid embedding substance is for instance one of epoxy, polymer, epoxide resin, diglycidyl ether of polypropylene glycol, nonenyl succinic anhydride, and dimethylaminoethanol.

Still further in accordance with the third embodiment of the present disclosure, the identification label is for instance a label having an adhesive or static cling and folded on itself.

Still further in accordance with the third embodiment of the present disclosure, the identification label has for instance a length greater than an inner diameter of the sample container.

Still further in accordance with the third embodiment of the present disclosure, the identification label has for instance an ink identification code on at least one of its exposed surfaces, an ink of the ink identification code being resistant to chemicals of the embedding substance.

Still further in accordance with the third embodiment of the present disclosure, the identification label has for instance the ink identification code on both of its exposed surfaces.

Still further in accordance with the third embodiment of the present disclosure, the identification label includes for instance an RFID or NFC tag or wireless communication device.

Still further in accordance with the third embodiment of the present disclosure, a printer is for instance provided to print the identification label.

Still further in accordance with the third embodiment of the present disclosure, ink is for instance provided for the printer, the ink being resistant to chemicals of the embedding substance.

Still further in accordance with the third embodiment of the present disclosure—an inked ribbon is for instance provided for the printer, ink of the inked ribbon being resistant to chemicals of the embedding substance.

Still further in accordance with the third embodiment of the present disclosure, a reader is for instance provided for the RFID or NFC tag or wireless communication device.

Still further in accordance with the third embodiment of the present disclosure, a reader and encoder is for instance provided for the RFID or NFC tag or wireless communication device.

### DESCRIPTION OF THE DRAWINGS

FIG. 1 is a perspective view of a removal of a label from a backing substrate in accordance with a method of identifying embedded samples for microscopy, in accordance with the present disclosure;

FIG. 2 is a folding of the label of FIG. 1 in accordance with the method of the present disclosure;

FIG. 3 is a further view of the folding of the label of FIG. 1;

FIG. 4 is a perspective view of a manipulation of the label of FIG. 1 in accordance with the method of the present disclosure;

FIG. 5 is a perspective view of a manipulation of a sample container in accordance with the method of the present disclosure;

FIG. 6 is a perspective view of a partial filling of the sample container with liquid embedding substance in accordance with the method of the present disclosure;

FIG. 7 is a perspective view showing a manner of holding the sample container with liquid embedding substance prior to an insertion of the label therein;

FIG. 8 is a perspective view of an insertion of the label in the sample container partially filled with embedding substance;

FIG. 9 is a perspective view of the sample container with the label as submerged with embedding substance;

FIG. 10 is a perspective view of the sample container with resin and the label prior to polymerization; and

FIG. 11 is a perspective view of the embedded sample with label therein.

FIG. 12 is a schematic view of a kit with a sample container with embedded sample and label in accordance with the present disclosure.

### DETAILED DESCRIPTION

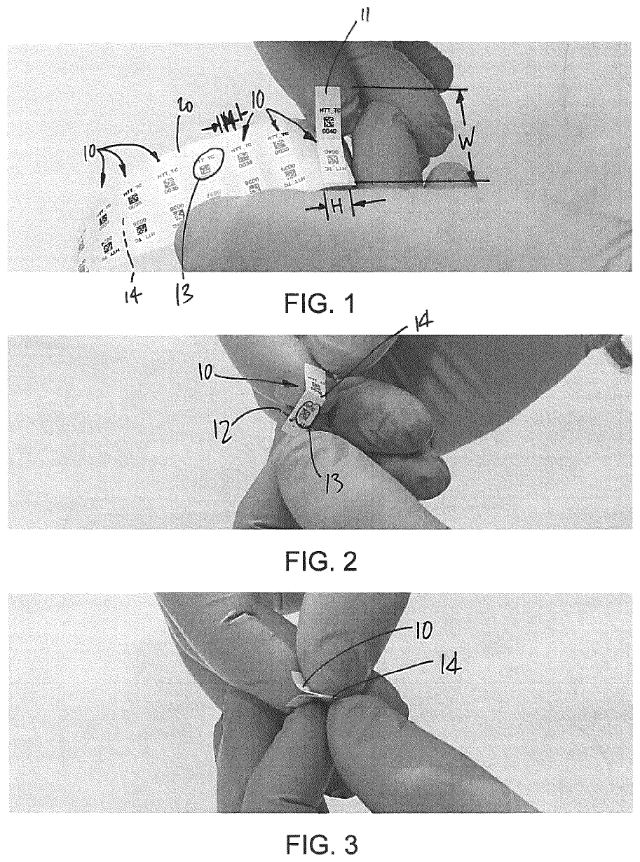

Referring to FIGS. 1 to 11, exemplary steps of a method for identifying embedded samples for microscopy are shown, for instance in a contemplated sequence. Some of the illustrated steps may not be required, while additional steps may be present. Moreover, some of the steps may be reversed.

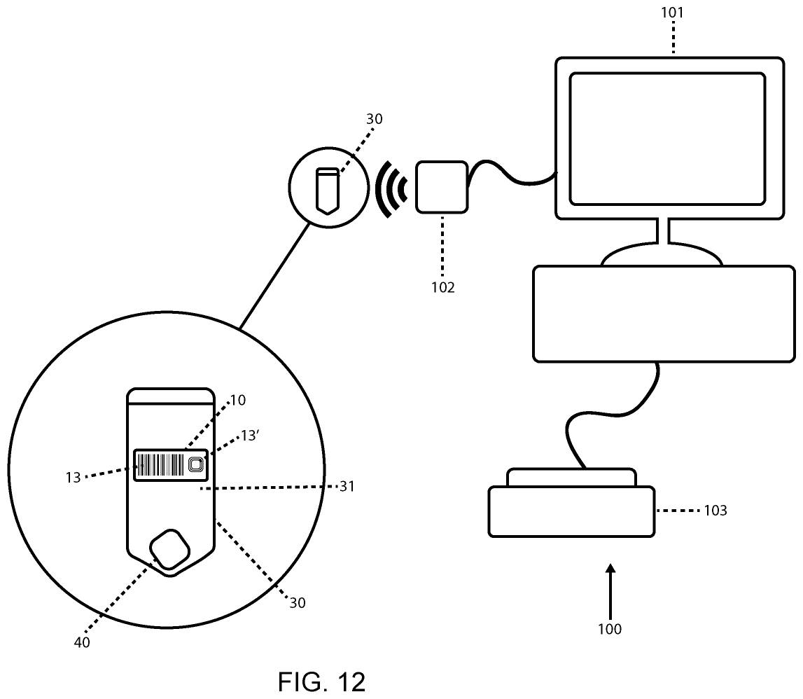

Referring now to FIG. 1, a series of identification labels 10 are releasably adhered to a backing liner 20 (also known as a backing strip or substrate, silicon or siliconized liner, release liner, etc). Alternatively, each label 10 may have a dedicated backing, although this is not shown. Each of the labels 10 has a top surface 11, a bottom surface 12 with or without adhesive, and identification codes 13. The identification codes 13 may be unique to each label 10, i.e., the identification codes 13 on one of the labels 10 is different that the codes 13 on any other label 10 supported by the backing liner 20. It is also contemplated to have a plurality of the same identification codes 13. For instance, is possible that a plurality of the same sample be produced simultaneously, whereby such samples will have the same information and hence the same identification code 13. As another example, a laboratory may make a number of samples from the same tissue, resulting in multiple copies of an identical sample, whereby such copies may have the same information and the same identification code 13. In the illustrated embodiment, the identification code 13 may be a barcode of any type (including 2D bar codes, data matrix, QR codes), color codes, and/or indicia. The label 10 has a relatively small size, typically between 6 and 50 millimeters in width W, for 3 and 15 millimeters in height H as shown in FIG. 1, considering that it has to be received in a sample container as detailed hereinafter. The identification codes 13 may be pre-printed or printed in situ, and thus are made of ink, for instance from a thermal transfer printer or ink jet printer provided such printers can produce an identification code of small enough size for the label 10. Other types of printers may include, non exhaustively, laser, direct thermal, digital, flexo, UV, laser etching. The material of the label 10 is a chemical resistant thermoplastic label material that can also resist to exposure to unpolymerized resin (e.g., labels from GA International Inc. compatible with inkjet printing, thermal-transfer printing). Likewise, the ink or the inked ribbon chosen has a similar property. The printing can be done on the top surface 11, but as label 10 may be folded prior to being embedded, the printed identification codes 13 appear on both sides or possibly on one side of the folded label 10. In another embodiment, the labels 10 are part of a roll, a sheet, etc and have no adhesive, the labels 10 being separable from one another by a tear strip or tear strips. Yet in another embodiment the label 10 is a static cling label and has no adhesive, the label can adhere to itself when folded due to static forces. Such labels 10 may be printed on one or both sides. The present disclosure may refer to identification codes 13 being on both sides hereinafter, but this should not be construed as a limitation as the identification code 13 may be on a single side, or even absent if a signal-emitting tag is present. The pre-printing or printing of an identification code 13 may not be necessary when a signal-emitting tag is present (represented by 13 in FIGS. 1-11 and shown as 13′ in FIG. 12), as a RFID encoder, a NFC encoder or like encoder technology may be used to electronically read/scan or encode/inscribe identification data at an earlier or later point in the process including prior to or after sample embedding.

As shown in FIG. 2, once the label 10 is removed from the backing liner 20, it is folded in half via fold line 14. The fold line 14 may be a pre-perforated line, or weakness in the label 10 to facilitate its folding in half. A visual mark may be alternatively or additionally provided on the label 10 at the fold line 14 to assist in the folding. The method also may rely on the user's dexterity for the label 10 to be folded in half, without any of the above assistance lines or perforation. Alternatively, this step may be automated, with the use of a robot or automated component. The adhesive on the bottom surface 12 self-adheres, insuring that the label 10 remains folded. As another embodiment, the label 10 is simply separated from a roll, sheet, etc, with identification code 13 already thereon (on one or both sides). The label 10 may be small enough not to have to be folded. Yet as another embodiment a static cling labels without adhesive can be used wherein the two parts of the label can adhere to each other via static forces.

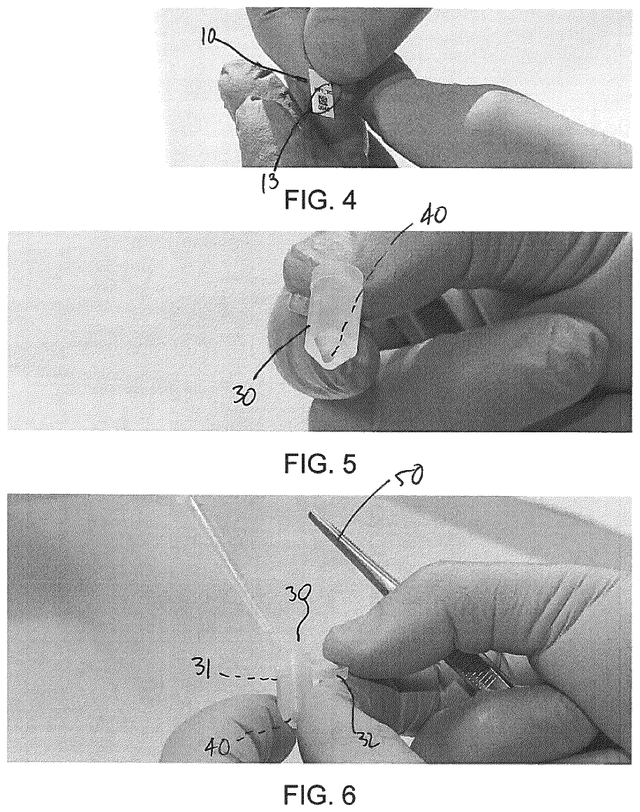

FIG. 3 shows a further step in the folding process, whereas FIG. 4 shows the folded label 10. The image of FIG. 4 may also be a label 10 detached from a roll or sheet, without any fold therein. As a result of the folding, in an embodiment both sides of the label 10 have the identification code 13 thereon (though not necessary). The identification code 13 may be the same on both sides of the label 10. While not shown, once the label 10 is removed from the liner 20 and folded in the illustrated manner, or even prior to folding, the label 10 is associated with a sample 40 that will be received in the sample container 30, as in FIG. 5—the sample container 30 may have other names, including resin container 30. There are different ways to associate the sample 40 with the label 10. According to an embodiment, a scan of the label 10 is made if the identification code 13 is one that is scannable, such as a barcode. As another possibility, the information on the identification code 13 may be entered manually in a database, as related to the specific sample 40. As another possibility, information in a RFID tag (High Frequency (HF) or Ultra-High Frequency (UHF), for example), Near Field Communication NFC tag or like signal-emitting tag comprises information related to sample 40. The information may be encoded before or after the signal-emitting tag is introduced in the container 30, using an appropriate encoder (e.g., RFID encoder, NFC encoder, etc). As another embodiment, the tags may be pre-encoded with data, such that a RFID reader or NFC reader is required (as opposed to encoders). Such tags may be in supplement to the identification code 13, to provide another means of identification of the embedded sample. It is also considered to envelop such tags in a folded label 10 due to the mechanical interference between the folded label 10 and the sample container 30 allowing the folded label 10 to be in a given orientation in the resin container 30. Therefore, during the method of the present disclosure, the correlation between any label 10 and its associated sample 40 is documented and recorded, such that the embedded sample 40 can be identified using the identification code 13.

Referring to FIG. 6, with the sample 40 in the sample container 30, liquid resin 31 is inserted in the sample container 30, with any appropriate tool, such as a pipette (although other tools could be used). Although the expression “liquid resin” is used, other expressions can be used for the liquid received in the sample container 30, such as epoxy, polymer, etc. The “liquid resin” may for example be low viscosity Spurr's resin, such as ERL 4221—epoxide resin, DER 736—diglycidyl ether of polypropylene glycol, NSA—nonenyl succinic anhydride, or DMAE—dimethylaminoethanol, although other resins may also be used. Likewise, while the expression “sample container 30” is used herein, other expressions can be used to describe the sample container 30, such as container, resin container, capsule, a mold, a multi-cavity mold for producing simultaneously numerous embedded samples, etc. The “sample container” may for example be BEEM™ embedding capsules, size 00, 8 mm I.D., or gelatin capsules, size 0, 7.34 mm I.D., again as non-limitative examples (15 mm I.D. or less). Materials used for the capsules may include polymers or gelatin, as examples. It should be specified that, although the expression “liquid” is used, it may include a gel resin as well. Other types of chemicals and substances can be used to achieve a polymerization and embedding of the sample into a solid matrix which are covered by the present disclosure. Moreover, while the figures show an individual sample container 30, it is contemplated to fill a plurality of interconnected molds or containers 30, for instance with each container 30 receiving a sample, resin and a label 10 in the manner described with reference to FIGS. 5 to 11.

As shown in FIGS. 5 and 6, a lid 32 may be provided with the sample container 30. The lid 32 may be pivotally connected to the sample container 30, so as to be pivotally closed onto the container portion of the sample container 30. The lid 32 may also be a standalone lid. Still as shown in FIG. 6, it is observed that the liquid resin 31 may not fully fill the sample container 30. For example, the liquid resin 31 fills up to two-thirds or three-fourths of the sample container 30, leaving an upper volume of the sample container 30 free of resin.

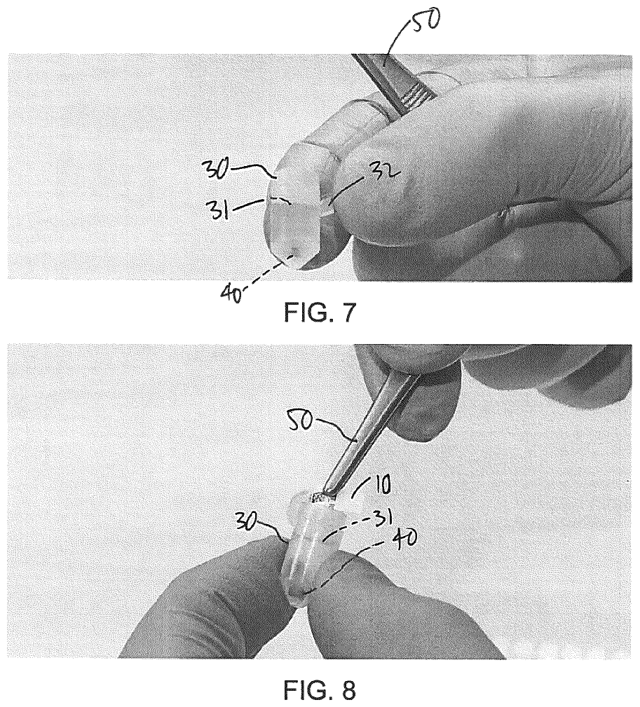

As shown in FIG. 7, the sample container 30 is generally held upright with the liquid resin 31 leaving the upper volume of the sample container 30 free of resin. Then, as shown in FIG. 8, the folded label 10 paired with the sample 40 received in the sample container 30 may be inserted, for instance using forceps 50. These forceps 50 facilitate the manipulation, but it is also contemplated to allow manipulation by fingers of the user, provided the user has sufficient dexterity to perform this task. As another embodiment, a robot or like automated equipment may perform this task. According to an embodiment, the folded label 10 has a length that is greater than a diameter of the sample container 30. Therefore, the folded label 10 may have a curvature in order to fit in the sample container 30. Because of the curvature, the folded label 10 will have a natural tendency to conform to the curvature of the sample container 30, in such a way that the identification code 13 is in close proximity to the wall of the sample container 30. This curvature may be created manually, with the constitution of the folded label 10—i.e., two layers with adhesive as a result of the fold 14—, ensuring that the folded label 10 maintains its curvature until insertion in the sample container 30. Moreover, the presence of the identification code 13 on both sides in an embodiment of the present disclosure simplifies the insertion in the sample container 30, in that the folded label 10 may simply be inserted in the sample container 30 without the requirement for intricate manipulations to ensure a specific orientation of the folded label 10.

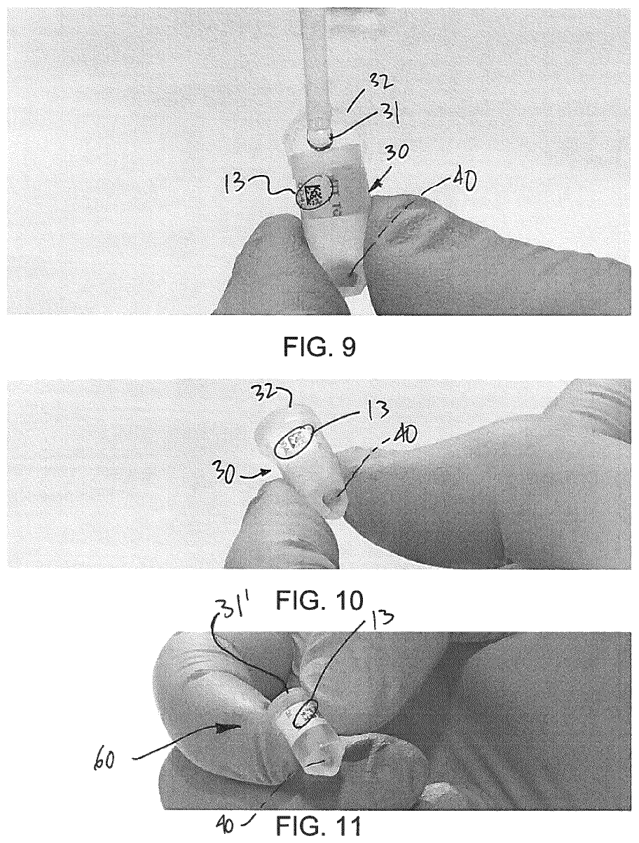

Referring to FIG. 9, once the folded label 10 is inserted in the sample container 30, at least partially above the level of liquid resin 31, additional liquid resin 31 is inserted to raise the level above that of the folded label 10, such that the folded label 10 becomes submerged by the liquid resin 31. Once this is achieved, the lid 32 may be positioned onto a container portion of the sample container 30 at which point the assembly of folded label 10, sample container 30 with liquid resin 31, and sample 40 may be solidified or cured, whether it be done by baking, chemicals or exposure to a UV treatment including LED UV treatment. Any other methods of curing, solidifying, hardening may be used. As an alternative embodiment, the folded label 10 may be inserted in the resin 31 of the sample container 30, as opposed to being inserted above a level of the resin 31. It is also contemplated to place the sample container 30 in an embedding treatment without the lid 32. As an alternative embodiment, the label 10 may be inserted in the capsule 30 prior to adding of any liquid. For example, the label 10 with identification code(s) 13 and capsule 30 (with or without signal emitting tag, RFID, NFC tags) may be sold as a set with the label 10 already inside the capsule 30.

Referring to FIG. 11, at the outset, the embedded sample 60 is shown, after the sample container 30 has been removed, with the solid resin 31′. The embedded sample 60 is therefore in a condition ready for sectioning and trimming. Beforehand, the user relies on the identification code 13 to uniquely identify the sample 40. Depending on the nature of the identification code 13, a scanner may be used, or the indicia provided on the identification code 13 may be run against a database, to identify the sample 40. If an electronic tag is used, such as RFID or NFC tag, the sample 40 is brought into proximity with the appropriate reader, such that an identification is made and is run against the database to identify the sample 40.

The various components described above may be provided in any appropriate manner. For example, there may be provided a kit comprising capsule 30 with printed label 10, printing kits (printer, label, with or without scanner, ink, and/or inked ribbon), embedding kits each comprising one capsule 30, one label 10, and/or liquid resin 31 for embedding, with possibly a combination of things inside the kit. It is also contemplated to insert an RFID (Radio Frequency Identification) tag, NFC (Near Field Communication) tag or like signal-emitting tag with the label 10.

In summary, the method for identifying embedded samples for microscopy may comprise folding the label 10 on itself for an adhesive to adhere halves of the label 10 together, or for a static cling non-adhesive label to adhere halves of the label 10 together, both exposed surfaces of the folded label 10 having the ink identification code 13, the ink and label 10 being resin resistant, associating the identification code 13 to a specific sample 40, inserting the specific sample 40 in the sample container 30, filling at least partially the sample container 30 including the specific sample 40 with a resin 31, inserting the label 10 associated to the specific sample 40 in the sample container 30 such that the label 10 is submerged by the resin 31, and placing the sample container 30 including the liquid resin 31 submerging the specific sample 10 and the label associated 10 with the specific sample for embedding treatment. Many, most or all of the steps may be done with the assistance or participation of robotic equipment and like automated apparatuses.

Referring to FIG. 12, a kit in accordance with the present disclosure is generally shown at 100. The kit 100 may include one or more sample containers 30 with an identification label 10. An identification code 13 and/or wireless tag 13′ is on the label 10, with data specifically associated to the sample 40. The kit 100 may comprise liquid embedding substance 31, or the sample 40 may already be embedded in the solidified embedding substance 31 along with the identification label 10. The kit 100 may also include a computer 101 with database or an application or non-transitory instructions readable by a computer for execution by the computer or like processor. A reader 102 with or without encoding capacity may also be part of the kit 100 for use with the wireless tag 13′. A printer, ink, inked ribbon for the printer, the ink and inked ribbon being resistant to chemicals of the embedding substance, all of which are shown at 103, may also be present in the kit 100.

1.-17. (canceled)

18. An assembly comprising:
at least one sample container,
solidified embedding substance in an inner cavity of the sample container,
a sample embedded in the solidified embedding substance, and
an identification label embedded in the solidified embedding substance, the identification label having data identifying the sample.

19. The assembly according to claim 18, wherein the at least one sample container has an inner diameter of less than 15 mm.

20. The assembly according to claim 18, wherein the sample container is one of an embedding capsule and gelatin capsule.

21. The assembly according to claim 18, wherein the sample container is part of a plurality of interconnected sample containers.

22. The assembly according to claim 18, wherein the solidified embedding substance is one of epoxy, polymer, epoxide resin, diglycidyl ether of polypropylene glycol, nonenyl succinic anhydride, and dimethylaminoethanol.

23. The assembly according to claim 18, wherein the identification label is a label having an adhesive or static cling and folded on itself.

24. The assembly according to claim 18, wherein the identification label in the solidified embedding substance has a length greater than an inner diameter of the sample container.

25. The assembly according to claim 18, wherein the identification label has an ink identification code on at least one of its exposed surfaces, an ink of the ink identification code and the label being resistant to chemicals of the embedding substance.

26. (canceled)

27. The assembly according to claim 18, wherein the identification label includes an RFID or NFC tag or wireless communication device.

28. A kit comprising:
at least one sample container adapted to receive a sample and an embedding substance solidifiable to embed items in the at least one sample container,
liquid embedding substance adapted to be received in an inner cavity of the sample container,
an identification label adapted to be received in an inner cavity of the sample container and configured to have data identifying the sample in the sample container, the label being resistant to chemicals of the embedding substance.

29. The kit according to claim 28, wherein the at least one sample container has an inner diameter of less than 15 mm.

30. The kit according to claim 28, wherein the sample container is one of an embedding capsule and gelatin capsule.

31. The kit according to claim 28, wherein the sample container is part of a plurality of interconnected sample containers.

32. The kit according to claim 28, wherein the liquid embedding substance is one of epoxy, polymer, epoxide resin, diglycidyl ether of polypropylene glycol, nonenyl succinic anhydride, and dimethylaminoethanol.

33. The kit according to claim 28, wherein the identification label is a label having an adhesive or static cling and folded on itself.

34. The kit according to claim 28, wherein the identification label has a length greater than an inner diameter of the sample container.

35. The kit according to claim 28, wherein the identification label has an ink identification code on at least one of its exposed surfaces, an ink of the ink identification code being resistant to chemicals of the embedding substance.

36. (canceled)

37. The kit according to claim 28, wherein the identification label includes an RFID or NFC tag or wireless communication device.

38. The kit according to claim 28, further comprising a printer adapted to print the identification label.

39. The kit according to claim 28, further comprising ink for the printer, the ink being resistant to chemicals of the embedding substance.

40. The kit according to claim 28, further comprising an inked ribbon for the printer, ink of the inked ribbon being resistant to chemicals of the embedding substance.

41.-42. (canceled)
